(19) United States
(12) Patent Application Publication
(10) Pub. No.: US 2006/0203293 A1
(43) Pub. Date: Sep. 14, 2006

(54) Scanner printer multi-function apparatus

(75) Inventors: Takuya Yasue, Nagano-ken (JP); Yoji Sasai, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/373,481

(22) Filed: Mar. 10, 2006

(30) Foreign Application Priority Data
Mar. 11, 2005 (JP) 2005-068514

(51) Int. Cl. H04N 1/23

(52) U.S. Cl. 358/296

(57) ABSTRACT

If a scanner and a desktop printer are stacked, the occupied space is reduced. However, in the printer unit below the scanner unit, the operationality such as feeding papers may be reduced and the access to the inside may not easy in doing maintenance. In the structure in which the scanner unit is fixedly placed on the top of the printer, the scanner printer multi-function apparatus has a sliding mechanism for sliding back and forth as means for connecting the scanner unit and a printer unit. Fixing positions are provided on at least two points back and forth. Each of the positions can be freely and easily selected. At the backward position, the scanner unit and the printer unit are stacked like a multitiered box so that the space occupied by the whole of the apparatus can be minimized, while at the forward position, the backward paper feeding opening is opened so that the operationality of the printer unit can be improved.

### CROSS REFERENCE TO RELATED APPLICATION

The present application claims priority from a Japanese Patent Application No. JP 2005-068514 filed on Mar. 11, 2005, the contents of which are incorporated herein by reference.

### BACKGROUND OF THE INVENTION

1. Field of the Invention

The present invention relates to a scanner printer multi-function apparatus. Particularly, the present invention relates to a scanner printer multi-function apparatus in which a scanner unit is mounted on a printer unit.

2. Related Art

Recently, a multi-function apparatus including a scanner unit and a printer unit integrated has been known along with the popularization of digital printing of photographs. Here, a multi-function apparatus in which the scanner unit is stacked on the printer unit in order to reduce the overall size of the multi-function apparatus, as disclosed in Japanese Patent Application Publication No. 2004-260618.

In the above disclosed invention, a paper feed section of the printer unit projects to a back face side in the multi-function apparatus. Therefore, a wasted space is generated on both sides of the paper feed section when the multi-function apparatus is installed against a wall. Further, the operativity is not good.

### SUMMARY OF THE INVENTION

To solve the above-described problem, a first aspect of the present invention provides a scanner printer multi-function apparatus. The multi-function apparatus includes: a scanner unit having an substantially rectangular solid casing and a document platform on which a document is placed on the top surface of the casing, for optically reading the document placed on the document platform to generate image information; and a printer unit for recoding the recording medium, which is disposed below the scanner unit and has a substantially rectangular solid casing, a paper feed section for feeding a recording medium from a backside paper feeding opening disposed near the back end of the top surface of the casing into the casing and a paper discharge section for ejecting the recording medium fed by the paper feed section from the front of the casing. The casing of the scanner unit slides between a backward position at which the casing of the scanner unit covers the backside paper feeding opening and a forward position at which the backside paper feeding opening opens on the casing of the printer. When the casing of the printer unit is located on the backward position on the casing of the scanner unit, the casing of the scanner unit and the casing of the printer unit are in the shape of a substantially rectangular solid.

Therefore, when the paper feed section of the printer unit is not in use, the overall size of apparatus can be reduced. Additionally, when the apparatus is installed, the rear end can be adjacent to the wall.

In the above-described scanner printer multi-function apparatus, the printer unit may further include a frontside paper feeding opening disposed on the front of the casing. Therefore, the number of times at which the casing of the scanner unit moves can also be reduced, so that the usability can be improved.

In the scanner printer multi-function apparatus, the scanner unit may further include a document cover which opens/closes to the document platform around the back end of the document platform. Therefore, the document platform can be prevented from being damaged and polluted. Further, the document cover can be prevented from unexpectedly opening when the casing of the scanner unit is slid.

Here, all necessary features of the present invention are not listed in the summary of the invention. The sub-combinations of the features may become the invention.

### BRIEF DESCRIPTION OF THE DRAWINGS

FIG. 1 is a front perspective view of a scanner printer multi-function apparatus 10;

FIG. 2 is a back perspective view of the scanner printer multi-function apparatus 10;

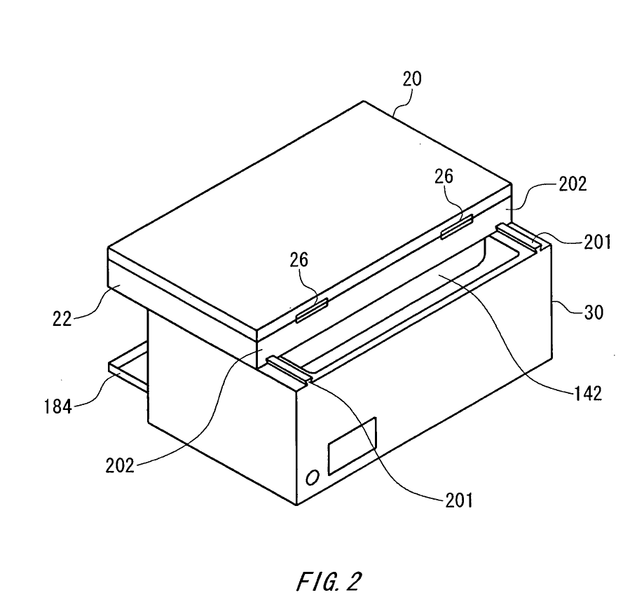

FIG. 3 is an external view showing a multitiered box like scanner unit 20;

FIG. 4 is an external view of a single printer unit 30.

FIG. 5 is an external view when a cover 24 of the scanner unit 20 is opened;

FIG. 6 is a cross-sectional view showing a feeding path in the printer unit 30;

FIG. 7 is a perspective view showing the interior of the printer unit 30;

FIG. 8 is a front perspective view of the scanner printer multi-function apparatus 10.

### DETAILED DESCRIPTION OF THE INVENTION

Hereinafter, the present invention will now be described through referred embodiments. The embodiments do not limit the invention according to claims and all combinations of the features described in the embodiments are not necessarily essential to means for solving the problems of the invention.

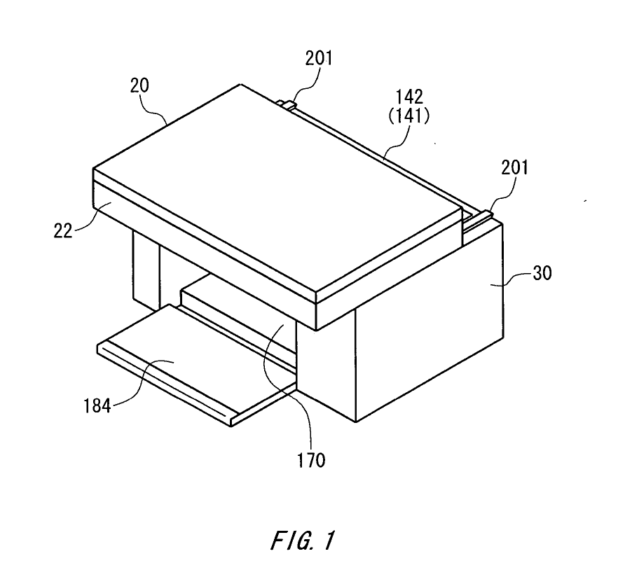

FIG. 1 is a front perspective view showing a scanner printer multi-function apparatus 10 according to an embodiment of the present invention. The scanner printer multi-function apparatus 10 includes a scanner unit 20 and a printer unit 30.

The printer unit 30 is disposed below the scanner unit 20 and has a substantially rectangular solid casing. The printer unit 30 includes a paper feed section 141 for feeding a recording medium from a backside paper feeding opening 142 disposed near the back end of the top surface of the casing into the casing, a paper discharge section 170 and a paper discharge outlet 174 for ejecting the recording medium fed by the paper feed section from the front of the casing, so that the printer unit 30 record on the recording medium. A paper discharge platform 194 is provided on the extension of the paper discharge section 170. The recording medium which has been recorded is deposited on the paper discharge platform. The paper discharge platform 184 is pivotally mounted in openable/closable manner to a frame 110 of the printer unit 30 through a hinge or pivot. The paper discharge platform 184 vertically arises in order to serve as a cover to close the paper discharge outlet 174.

The scanner unit 20 is formed of a rectangular solid both of which height and width are same as those of the printer unit 30, or of which size is approximately same as that of the printer unit 30. The scanner unit 20 connects to the printer unit 30 through a sliding mechanism 205 such that scanner unit 20 is slidably moved between a backward position at which the scanner unit 20 covers the backside paper feeding opening 142 and a forward position at which the backside paper feeding opening 142 is opened. The sliding mechanism 205 includes two rails 201 provided in the printer unit 30 and two grooves 202 provided in the scanner unit 20, which are engaged each other.

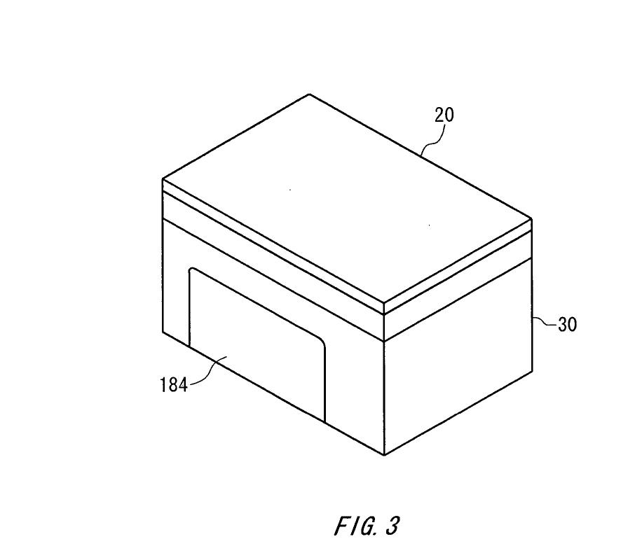

FIG. 3 shows the outward appearance of the printer unit 30 in idle state. Here, the scanner unit 20 moves to the backward position on the printer unit 30. When the paper discharge platform 184 is folded, the scanner unit 20 is stacked on the printer unit 30 in the form of such as a multitiered box and the whole shape is substantially rectangular solid. Therefore, when the printer unit 30 is in idle state, the entire size of the scanner printer multi-function apparatus 10 can be reduced. Additionally, when the apparatus is installed, the back end surface can be adjacent to the wall surface.

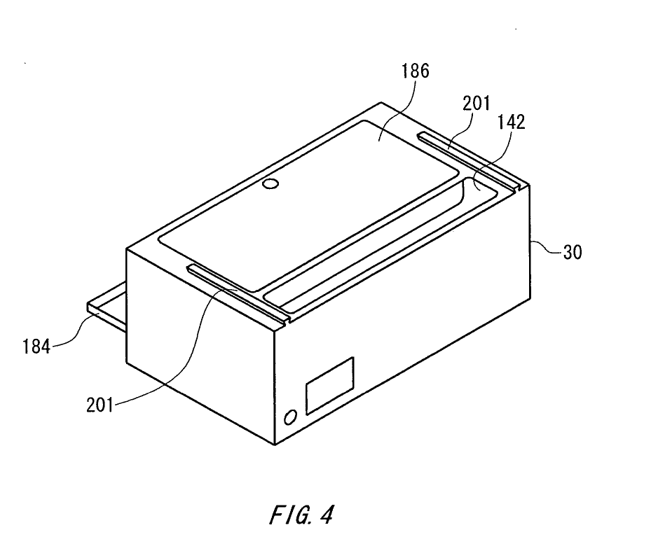

The scanner unit 20 is slid forward over the forward position and then released from the rails 201, so that the whole of the scanner unit 20 can be completely separated from the printer unit 30. FIG. 4 shows the outward appearance of only the printer unit separated from the scanner unit 20. The paper discharge platform 184 may operate as an openable/closable cover for covering the top of the printer unit 30. The paper discharge platform 184 can be removed when the inside of the printer unit 30 is maintained. In this case, the scanner unit 20 and the printer unit 30 may be electrically connected through a connector (not shown in the figure) in use to communicate information therebetween. When the scanner unit 20 is separated from the printer unit 30, the connector may be removed.

In the scanner printer multi-function apparatus 10, the scanner unit 20 has a document cover 24 which opens/closes around the hinge 26 provided near the back end thereof. A document platform 22 on which documents are placed is disposed under the document cover 24. The scanner unit 20 optically reads the reversed document which is placed on the document platform 22 to generate image information.

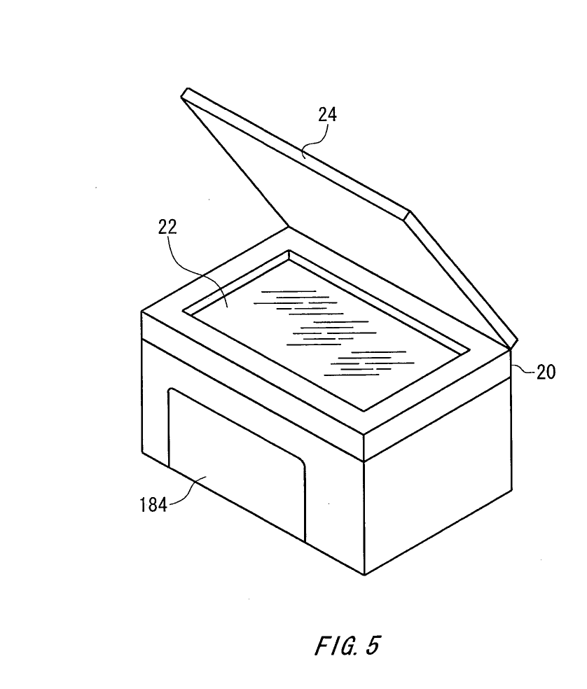

FIG. 5 shows the scanner unit 20 of which cover 24 is opened. The cover 24 is evenly fixes the document placed on the glass document platform 22 thereto and shuts out outside light. Therefore, an optical scanning d from beneath through the glass can be certainly performed. Additionally, the document platform 22 can be prevented from being polluted and damaged. Further, the cover 24 can be prevented from unexpectedly opening when the scanner unit 20 is slid.

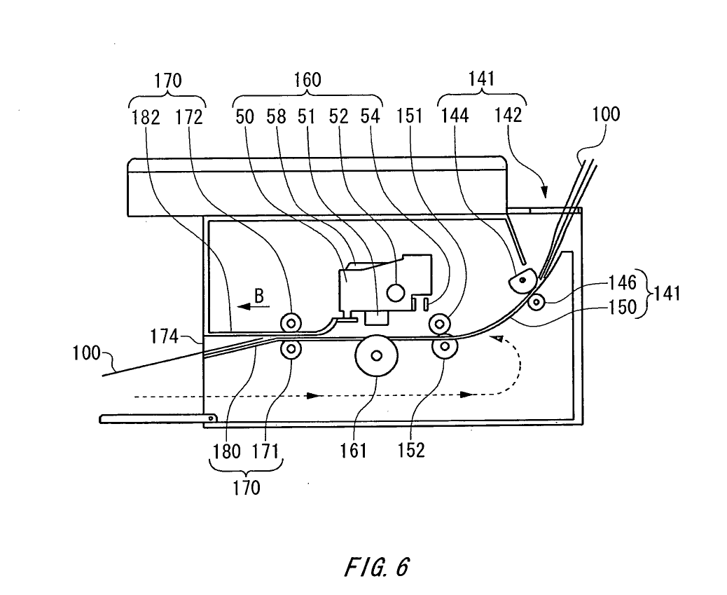

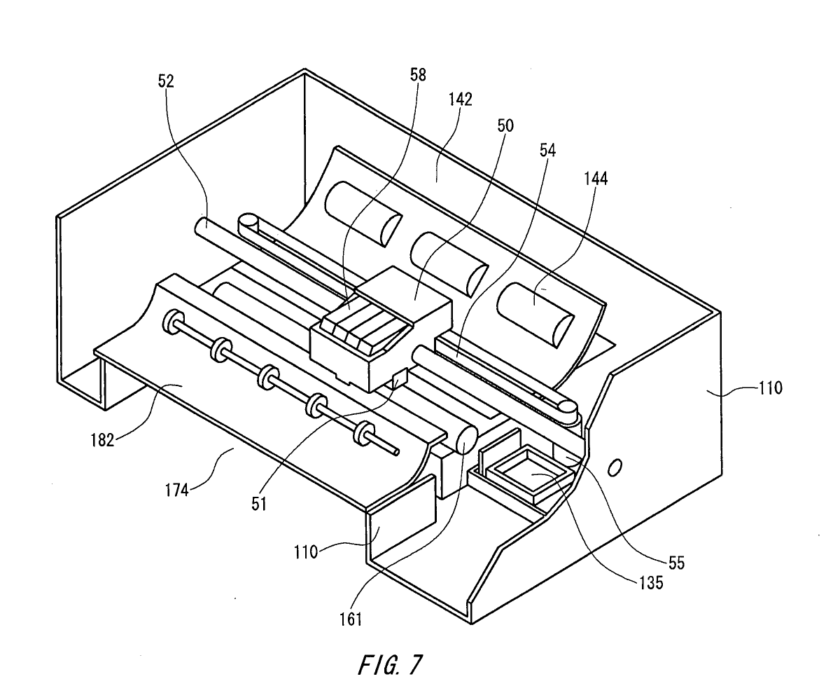

FIG. 6 is a cross-sectional view showing the cross section obtained by vertically cutting the inside of the printer unit 30 along transferring direction of the recording medium 100. FIG. 7 is a perspective view showing the outline of the printer unit 30 from which the casing and a part of the cover have been removed.

Now, it will generally describe the internal structure of the feeding path through which the recording medium passes from the paper feeding opening 142 to the paper discharge outlet 174 with reference to FIG. 6 and FIG. 7. The printer unit 30 according to the present embodiment employs an inkjet recording method. The printer unit 30 includes a paper feed section 141 for feeding the recording medium 100 inserted from the paper feeding opening 142 to a recording position, a recording section 160 for ejecting ink to the fed recording medium 100 to record on the same, an waste liquid section 135 for collecting the ink excessively ejected from the recoding section 160 as an waste liquid and a paper discharge section 170 for ejecting the recording medium which has been recorded to the outside of the printer unit 30.

The paper feed section 141 includes a paper feed guide 150 for guiding the recording medium 100 from the paper feeding opening 142 to the recording section 160, and a pair of a paper feed drive roller 144 and a paper feed compliance roller 146 which are disposed near the paper feeding opening 142. The paper feed guide 150 is a plate member bending downward from the paper feeding opening 142 to below a recording head 51. The paper feed guide 150 is supported by the frame 110. The paper feed roller 144 is rotatably supported by the frame 110. When the paper feed roller 144 is cut by a cross section vertical to the rotation axis, the shape is substantially D. The paper feed roller 144 is rotated around the rotation axis by the driving force from a motor (not shown in the figure). The paper feed compliance roller 146 is disposed such that the recording medium 100 is sandwiched between the paper feed compliance roller 146 and the paper feed drive roller 144 and rotatably supported by the frame 110.

Feed rollers 151 and 152 are disposed in the intermediate part between the paper feed section 141 and the recording section 160, which transfer the recording medium 100 fed from the paper feed section 141 onto a platen 161.

The recording section 160 includes a carriage 50, a guide shaft 52 supported by the frame 110 and passed through the carriage 50, an endless timing belt 54 gripped by the carriage 50 and a motor 55 for rotationally driving the timing belt 54. One or more ink cartridges 58 for storing ink and providing the same onto the recording head 51 and the recording head 51 for ejecting the ink to the recording medium 100 are mounted on the carriage 50. The recording section 160 further includes the platen 161 disposed opposite to the direction to which the recording head 51 ejects the ink droplets. The platen 161 extends parallel to the guide shaft 52 and is rotatably supported by the frame 110. The platen 161 is driven in synchronism with the paper feed drive roller 144 by a motor (not shown in the figure) for driving the paper feed drive roller 144.

The paper discharge section 170 includes a pair of plate-like under paper discharge guide 180 and upper paper discharge guide 182 for guiding the recording medium 100 from the position opposite to the recording head 51 to the paper discharge outlet 174, a paper discharge drive roller 171 disposed in the under paper discharge guide 180 side and a paper discharge compliance roller 172 disposed opposite to the paper discharge drive roller 171. The paper discharge drive roller 171 is rotatably supported by the frame 110. Additionally, the paper discharge drive roller 171 is driven in synchronism with the paper feed drive roller 144 by a motor (not shown in the figure) for driving the paper feed drive roller 144. The paper discharge compliance roller 172 is disposed such that the recording medium 100 is sandwitched between the paper discharge compliance roller 172 and the paper discharge drive roller 171 and rotarably supported by the frame 110.

According to the above-described configuration, the printer records on the recording medium 100 as follows. Firstly, when the recording medium 100 is inserted from the paper feeding opening 142, the paper feed drive roller 144 and the paper feed compliance roller 146 sandwich the recording medium 100. Then, the paper feed drive roller 144 is rotationally driven so that the paper feed compliance roller 146 is rotated along with the paper feed drive roller 144. Therefore, the paper feed drive roller 144 and the paper feeding opening 142 feed the recording medium 100 to the direction of an arrow B in the figure along the paper feed guide 150. The feed rollers 151 and 152 convey the recording medium 100 fed from the paper feed section 141 onto the platen 161.

When the recording medium 100 is fed between the recording head 51 and the platen 161, the motor 55 rotationally drives the timing belt 54 so that the timing belt 54 reciprocates the carriage 50 horizontally and along the direction vertical to the conveyance direction. Therefore, the recording head 51 reciprocates on the recording medium 100 and ejects ink to the recording medium 100 to record on the recording medium 100. After the carriage 50 reciprocates on the recording medium 100 once, the feed rollers 151 and 152 slightly shift the recording medium 100 and the carriage 50 is repeatedly reciprocated. Thus, the recording head 51 can eject ink all over the recording medium 100 to record on the same.

The feed rollers 151 and 152 further move the recording medium 100, so that the recording medium 100 arrives at the gap between the paper discharge drive roller 171 and the paper discharge compliance roller 172. The paper discharge drive roller 171 and the paper discharge compliance roller 172 sandwich the recording medium 100 in the gap. Then, the paper discharge drive roller 171 is rotationally driven so that the paper discharge compliance roller 172 is rotated along with the paper discharge drive roller 171. Therefore, the paper discharge drive roller 171 and the paper discharge compliance roller 172 convey the recording medium 100 between the under paper discharge guide 180 and the upper paper discharge guide 182 and eject the recording medium 100 to the outside of the printer unit 30 via the paper discharge outlet 174.

When the printer unit 30 is in idle state, the recording head 51 is guided by the guide shaft 52 and escaped to a standby position at the outside of the right end in FIG. 7 in the longitudinal direction of the platen 161. When the recording head 51 is located such position, the waste liquid section 135 covers the bottom surface of the recording head 51. Therefore, it can prevent the ink from clogging into the recording head 51 due to evaporating the solvent of the ink when the recording head is not used. When cleaning and flushing of the recording head 51 is performed while the printer unit 30 is used, the recording head 51 is moved in the longitudinal direction to a standby position of the outside of the platen 161.

In the above-described scanner printer multi-function apparatus 10, the printer unit 30 may further include therein a second recording medium feeding path being capable of feeding recording medium from the front. The dotted line shown in FIG. 6 represents an example of a recording medium feeding path added in this case. The recording medium feeding path can feed a relatively thin recording medium without problems although there is a steep slant at the turnaround in the right end in the figure. When a front paper feeding opening is used, the backward paper feeding opening 142 is not used so that the printer unit 30 can used without moving forward the scanner unit 20. Meanwhile, when a thick recording medium such as a postcard or a large-size print is recorded, the paper feeding opening 142 can be used. Therefore, the number of times at which the scanner is moved is reduced so that the usability can be further improved. Many examples of the feeding path have been known, so that the description of the specific configuration thereof is omitted.

While the present invention have been described with the embodiment, the technical scope of the invention not limited to the above described embodiment. For example, the printer unit 30 can be applied not only the inkjet recording apparatus but also various apparatus such as a copy machine having a paper feeding opening and a paper discharge outlet back and forth, a facsimile, a laser beam printer and a printer including a transfer roller with a magnetic latent image or an electrostatic latent image.

The scanner unit 20 placed on the top of the printer may be not only the flatbed scanner but also the other type of scanners. The scanner unit 20 may be disposed on an empty space in the top of the printer unit 30 without reducing paper feed ability of the printer unit 30 by sliding forward by a length equal to the width of the paper feeding opening 142 of the printer unit 30 and opening the paper feeding opening 142. Additionally, the sliding mechanism 205 is not only the sliding mechanism 205 according to the present embodiment but also a roller may be used.

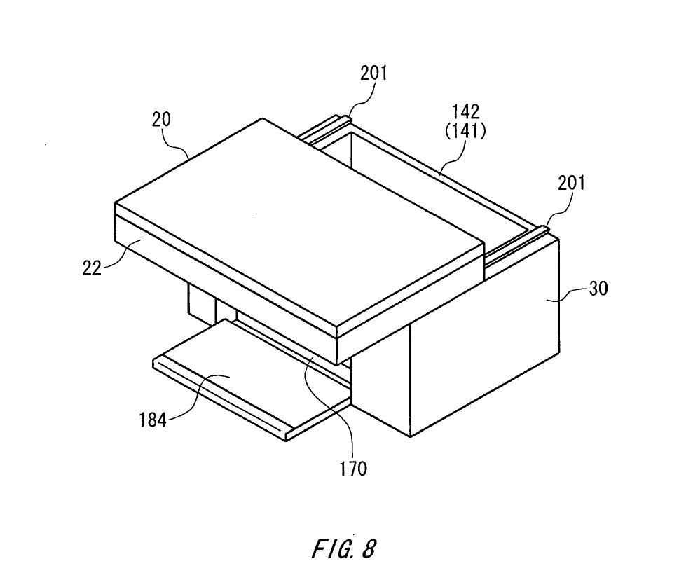

FIG. 8 shows that the scanner unit 20 is slid more forward than in FIG. 1 on the printer unit 30 in the scanner printer multi-function apparatus 10 according to the present embodiment. As shown in FIG. 8, the scanner unit 20 can be slid from the position at which the paper feeding opening 142 is opened to further forward position, so that the following effect can be generated. Firstly, when the recording medium 100 fed from the backward paper feeding opening 142 is clogged in the printer unit 30, the scanner unit 20 is slid to the position shown as FIG. 8, so that the user can put his/her hand into the printer unit 30 to remove the clogged recording medium 100. Additionally, when the ink cartridge 58 is replaced, the top face above the ink cartridge 58 is opened, and then, the scanner unit 20 is slid to a position shown in FIG. 8 and the ink cartridge 58 is exposed, so that the ink cartridge 58 can be easily replaced. Further, a lever for adjusting the gap between the recording head 51 and the platen 161, and a lever for escaping a paper discharge tray during recording on a CDR are disposed such that both levers are exposed at the position shown in FIG. 8, so that the apparatus can be made compact. When the scanner unit 20 is removed from the printer unit 30, the connecter which electrically connects the printer unit 30 and the scanner unit 20 can be attached/detached in the state shown as FIG. 8. Additionally, when the guide for the CDR is pulled out to the front of the apparatus during recording on the CDR, the scanner unit 20 is moved to the position as shown in FIG. 8, so that the user can put his/her hand into the printer unit 30 to push the guide to move to the front of the apparatus. Further, any spare ink cartridge 58 may be prepared in the empty space in the printer unit 30 as shown in FIG. 8.

It is apparent to persons skilled in the art that various alternations and improvements can be added to the above-described embodiment. It is apparent from the scope of the claims that the embodiment added such alternation or improvements can be included in the technical scope of the invention.

What is claimed is:

1. A scanner printer multi-function apparatus comprising:
a scanner unit having a substantially rectangular solid casing and a document platform on which a document is placed on the top of the casing, for optically reading the document placed on the document platform to generate image information;
a printer unit disposed below the scanner unit, for recording a recording medium, having a substantially rectangular solid casing, a paper feed section for feeding the recording medium from a backward paper feeding opening disposed near the back end of the top face of the casing into the casing and a paper discharge section for ejecting the recording medium fed by the paper feed section from the front of the casing, wherein
the casing of the scanner unit slides between a backward position at which the casing of the scanner unit covers the backward paper feeding opening and a forward position at which the backward paper feeding opening is opened on the casing of the printer unit, and
the casing of the scanner unit and the casing of the printer unit are in the shape of substantially rectangular solid when the casing of the scanner unit is located at the backward position on the casing of the printer unit.

2. The scanner printer multi-function apparatus according to claim 1, wherein the printer unit further comprises a front paper feeding opening disposed on the front of the casing.

3. The scanner printer multi-function apparatus according to claim 1, wherein the scanner unit further comprises a document cover which opens/closes to the document around the back end of the document platform.
